(19) United States
(12) Patent Application Publication
(10) Pub. No.: US 2015/0074036 A1
(43) Pub. Date: Mar. 12, 2015

(54) KNOWLEDGE MANAGEMENT SYSTEM

(71) Applicant: AGT International GmbH, Zurich (CH)

(72) Inventors: Gadi Lenz, Zikhron Ya'aqov (IL); Itzhak Adziashvili, Haifa (IL); Yaacov Apelbaum, Sayville, NY (US); Ram Ben Tzion, Ramat Hasharon (IL); Matania Zvi Kochavi, Old Westbury, NY (US)

(21) Appl. No.: 14/484,058

(22) Filed: Sep. 11, 2014

Related U.S. Application Data
(60) Provisional application No. 61/876,993, filed on Sep. 12, 2013.

(51) Int. Cl. G06N 5/04

(52) U.S. Cl. CPC G06N 5/048; G06N 5/043
USPC 706/52

(57) ABSTRACT

A knowledge management system configured to integrate information and to distill non-obvious knowledge from data by applying various engines operative in accordance with available information knowledge.

### CROSS-REFERENCE TO RELATED APPLICATIONS

This application claims the benefit of U.S. Provisional Application Ser. No. 61/876,993 filed on Sep. 12, 2014 which is hereby incorporated by reference

### FIELD AND BACKGROUND OF THE INVENTION

The present invention relates generally to cloud computing, and specifically, relates to knowledge management.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an overview of network diagram depicting multiple city clouds, various information sources linked to a knowledge cloud, according to an embodiment;

FIG. 2 is network diagram of a city cloud and its various functionalities and linked resources and clients, according to an embodiment;

FIG. 3 is network diagram of a knowledge cloud and its various functionalities and linked resources and clients, according to an embodiment;

FIG. 4 is a Data-Information-Knowledge-Wisdom (DIKW) pyramid depicting the levels of information that will be dealt in the different clouds, according to an embodiment;

FIG. 5 is a high-level workflow of a Knowledge Cloud (KC), according to an embodiment;

FIG. 6 is a schematic view of an expert system employed as a part of a KC, according to an embodiment.

FIG. 7 is a cloud system view of a knowledge cloud depicting “Anything as a Service” (XaaS) layers, according to an embodiment;

FIG. 8 is a stacked system view depicting infrastructural elements of a KC, according to an embodiment; and

FIG. 9 is a layered view depicting baseline high-level architecture of a KC, according to an embodiment;

It will be appreciated that for clarity, elements may not be to scale or may be repeated among the figures to indicate corresponding or analogous elements.

### DETAILED DESCRIPTION OF THE PRESENT INVENTION

In the following detailed description, numerous details are set forth in order to provide a thorough understanding of the invention. However, it will be understood by those skilled in the art that the present invention may be practiced without these specific details. Furthermore, well-known methods, procedures, and components have not been described in detail so as not to obscure the present invention.

According to some embodiments of the present invention, a computer network implemented knowledge management system.

The following terminology will be used through out the application:

“Knowledge Cloud (KC)” refers to a computer network operative primarily as a knowledge center that aggregates and processes higher levels of information.

“City Cloud (CC)” refers to a computer network configured to provide management of multiple city/municipal domains, and management platforms, analytic tools capabilities, and delivery tools.

“Data” refers to content in either structured, or unstructured form. “Unstructured data” means that it lacks metadata and therefore is not directly usable in an automatic way by analysis engines designated to perform further processing.

“Information” refers to post analytics content.

“Non-obvious knowledge” refers to information enhanced with Subject Matter Expertise (SME) insight or Case Based Reasoning (CBR) input.

“Wisdom” refers to knowledge enriched with additional inputs.

“Prosumer” refers to an entity who is both a provider and consumer of information.

“Infrastructure as a Service (IaaS)” refers to computer infrastructure, being delivered as a service through virtualization of a physical device or resource.

“Platform as a Service (PaaS)” refers to providing development, deployment, and administration tools as a service.

“Software as a Service (SaaS)” refers to providing software applications as a service.

“Media” refers to broadcast television, radio, and online press.

“Consumer space” refers to consumer access to the system.

“Extensibility” refers to a capacity to accommodate additional functionality and scale accordingly.

“Integration” refers to adaptation and specific configuration required for each new domain KC deployed.

“Business Intelligence” refers to computer displayed, visual content conveying quantitative information; e.g. charts, plots, virtual gauges, and heat maps.

“Analysis engine” refers to a computer program that performs some form of analysis on data or information by one or more algorithms appropriate for the specific analysis task at hand

“Reasoning engine” refers to a piece of software able to infer logical consequences from a set of asserted facts or axioms.

“Inference engine” refers to a computer program that tries to derive answers from a knowledge base (It is considered to be a special case of a reasoning engine.)

It should be noted that for the purposes of this document, the computing and network capabilities of the present invention are discussed in the context of a city cloud and a knowledge cloud by example only.

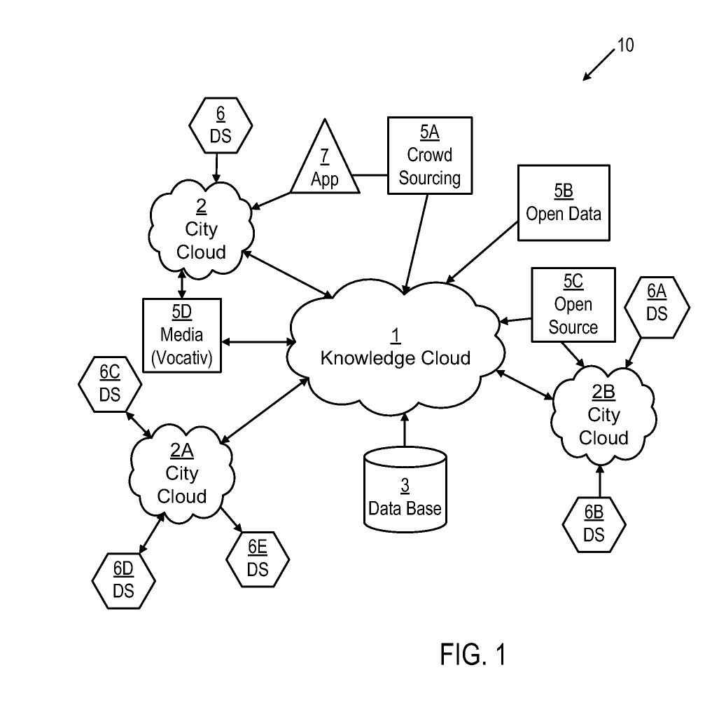

Turning now to the figures, FIG. 1 is an overview of knowledge cloud (KC) 1 linked to city clouds (CC) 2-2C that are in turn linked to city applications 7, data sources 6-6E, and media 5D. KC 1 may be further linked to resources like crowd sourcing 5A, open data 5B, open sources 5C, according to a non-limiting embodiment.

KC 1 may be fed by multiple CCs 2-2B through 2-way links to facilitate sharing of the cities' data with KC 1 thereby enhance and enrich the knowledge in KC 1 and CC 2-2B may gain new insight from the broad and deep knowledge residing in KC 1.

Notably, data sources 6-6C may be implemented as sensors feeding CCs 2-2B but usually not feeding KC 1 so as to minimize the transfer of the typically large amounts of data captured. Sensor data of CCs 2-2B is processed by a low level processing engine to impose structure on the typically unstructured sensor data in preparation for further processing by analysis engines implanted either in a CC or in KC 1, according to embodiments.

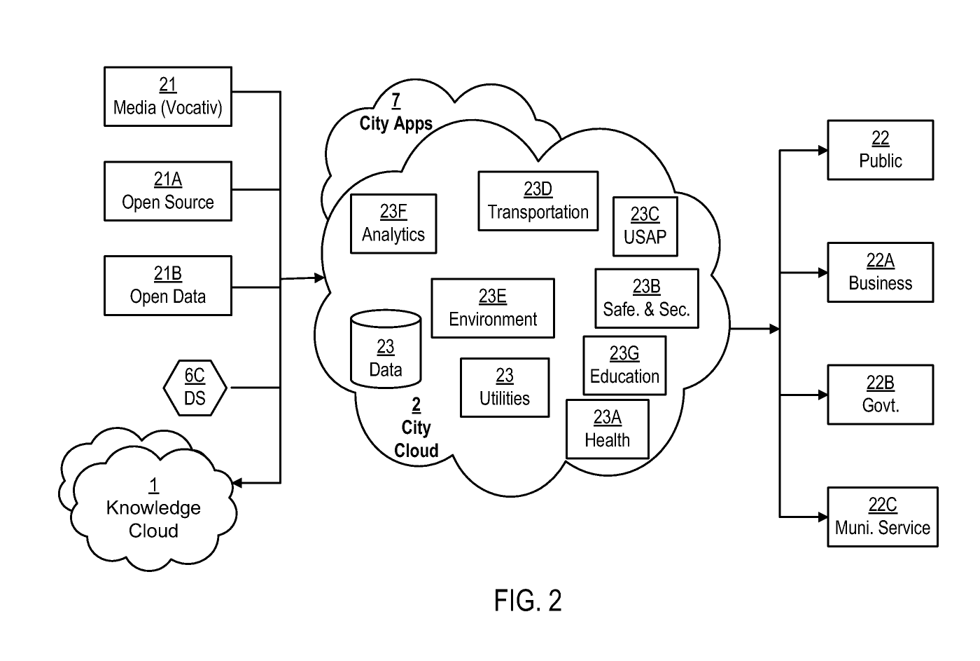

FIG. 2 is network diagram of a city cloud and its various functionalities, linked resources, and clients, according to a certain embodiment. CC 2 is a multi-domain, multi-agency urban management cloud-based-platform with data 23 and analytic capabilities 23F, and citywide Unified Situation Awareness Picture (USAP) 23C.

Additional examples of services that may be hosted in CC 2 may include inter alia, Video Management, VMS manager, Video Analytics, Data Services, Face Analytics and Recognitions, Automatic Vehicle Tracking, Investigation, Sensor Management including Sensor Type Managers, Accessors and Camera State, Shift Management, Rules Management, Event Management, Entity/Object and Suspects Management, and Link Analysis, Mobile Forces/Resource Management, Task Management, Big Data Analytics, Business Intelligence (BI) and Data Analytics, Data Reporting, Manual & Automatic procedures/FOGs, Configuration Management, DRP Management, and Simulation Framework

Examples of urban agencies supported on CC 2 platform may include, inter alia, environment 23E, utilities 23, transportation 23D, safety and security 23B, health 23A, and education 23G.

CC 2 may also be fed by various information sources like, inter alia, media 21, open source 21, open source 21A open data 21B, KC 1, and data providers 6C.

Data providers 6C may be implemented as any of the following, inter alia, fixed and mobile sensors, databases, media, open sources, crowd sourcing, mobile prosumers delivering text, audio, video, imagery and contextual information.

In certain embodiments data is pre-processed prior to being fed to CC 2 to reduce bandwidth load and in other embodiments analysis engines are applied to structured data to perform processing like, inter alia, video data tagging, automatic speech recognition (ASR), video output and rendering to text, and optical character recognition (OCR).

Individual of the public may interact with the city and CC 2 through city applications 7 created by the public and professional party developers.

As shown, CC 2 itself feeds data, processed sensor data, and results analytics processing, to clients like the public 22, to business 22A, to government 22B, municipal services 22, in some embodiments.

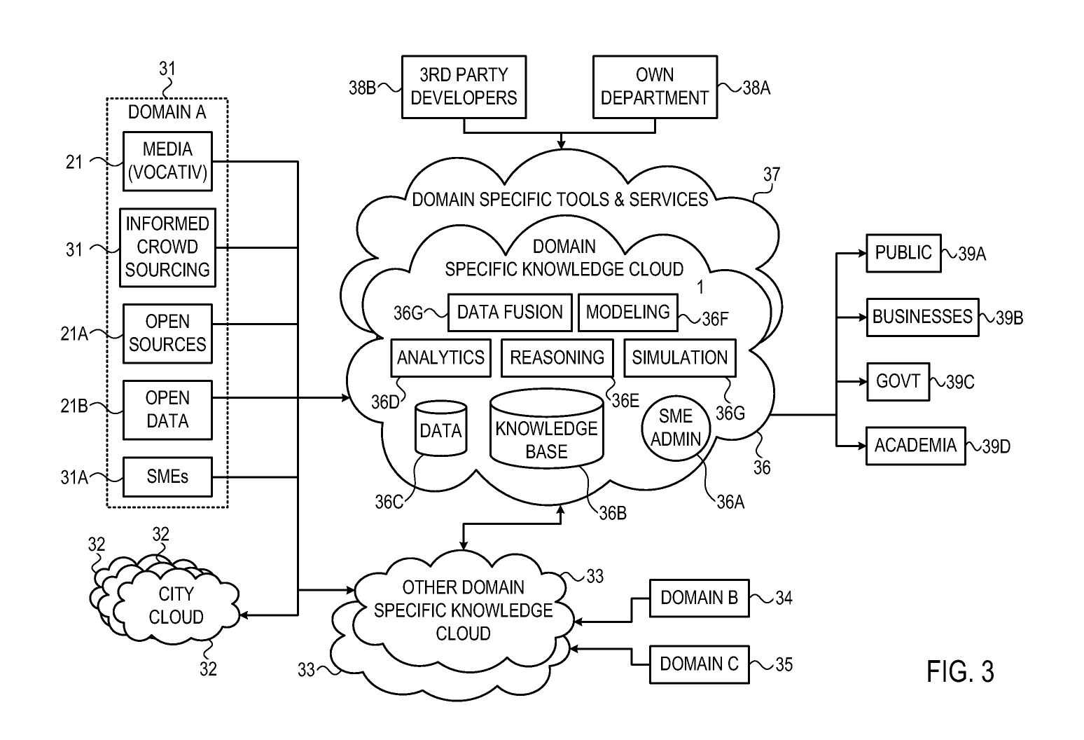

FIG. 3 is network diagram of KC 1 implemented as a domain specific knowledge repository with, a database 36 and knowledge base 36B, powerful analytic capabilities 36D, reasoning engines 36E, modeling and simulation capabilities 36F and 36G, respectively, SME administration 36A, a set of tools and services for data retrieval 37, according to a non-limiting embodiment.

Operational knowledge like Subject Matter Expert (SME) expertise, Concept of Operations (CONOPS), globally lessons learned, and best practices may be stored in a dedicated knowledge base whereas other data such as analyzed data, metadata, obtained from multiple CCs, may be stored separately, according to some embodiments.

Data sources may include, inter alia, accessible databases 36C, open sources and open data sets 21 and 21A, SME knowledge, media 21, crowd sourced data 31, operational data from CCs 32, and other domain specific knowledge 33 associated with domains B and C, 33 respectively 34, for example.

In situations in which incoming data is well-structured, normalized and in some standardized format, little additional processing is required to enable input into the more sophisticated analysis engines.

In other cases in which data is unstructured, has gaps, is redundant, or is in proprietary format, processing engines configured to format data, transform the data before processing by more sophisticated engines as noted above.

The analytic capabilities 36D and 36E enable analysis, simulation, modeling, for example, so that the resulting information may be further enhanced when analyzed in view of the knowledge bases found there as will be further discussed.

The resulting added insight may then in turn be used when deploying new CCs.

The set of tools and services 37 is configured to assist clients with data retrieval, analysis, visualization, according to embodiments.

KC 1 is accessible for both inputting of information as well as consuming knowledge. As there are many types of knowledge that the KC 1 may produce, input and output interfaces are created and APIs made available to anyone who is information source provider, a tool developer 38A and 38B potential knowledge consumer 39A-39B.

In regards to several key differences between a KC 1 and a CC 2, it should be appreciated that in some embodiments KC 1 may use input information sources similar to CC 2 with a few differences:
As noted above, KC 1 does not usually deal directly with raw data coming from sensors.
KC 1 may rely much more on domain experts in the form of Subject Matter Expert knowledge (SME)s as will be further discussed. While CC 1 may rely on SMEs who are part of the municipal departments, the SMEs of KC 1 are much higher level SMEs with global experience
KC 1 is a global repository of knowledge and therefore may include a filtering mechanism needed to ensure the information is credible and therefore some data filter is necessitated.
CC is primarily an operational or management platform while KC is primarily a knowledge platform

KC 1 is a complex system for the management and analysis of knowledge that integrates a large number of tools and subsystems. Following is a summary of the main points of its variability:

In terms of data input types KC 1 may handle structured, semi-structured, and unstructured data.

In terms of data types, KC 1 may handle traffic data, pollution data, crime data, data from external systems with pre-defined structures that may be known or unknown format.

In terms of data formats, KC 1 may handle textual data, binary data, media data (e.g. wmv, mpg, image file or file stream).

In terms of data storage mechanism, KC 1 may handle raw storage, processed storage, persistent storage, volatile storage (caching), RDMS, No-SQL, and blob storage.

In terms of data pre-processing, KC 1 may handle sensor data pre-processing, media data pre-processing, data aggregation, applying SME knowledge, pre-processing by external expert systems.

In terms of analytical processing, KC 1 may handle data fusion, data mining, modeling, simulation, video analytics, machine learning (supervised & unsupervised), facial recognition, OCR.

In terms of data delivery and packaging mechanism, KC 1 may handle on demand data retrieval, scheduled data delivery, data publishing, data query, data compression.

In terms of communication types, KC 1 may handle cloud-to-cloud, cloud-to-system, cloud-to-application.

In terms of processing types online processing, KC 1 may handle (request-response), offline processing (includes batch), workflows, state machine, rule based engine.

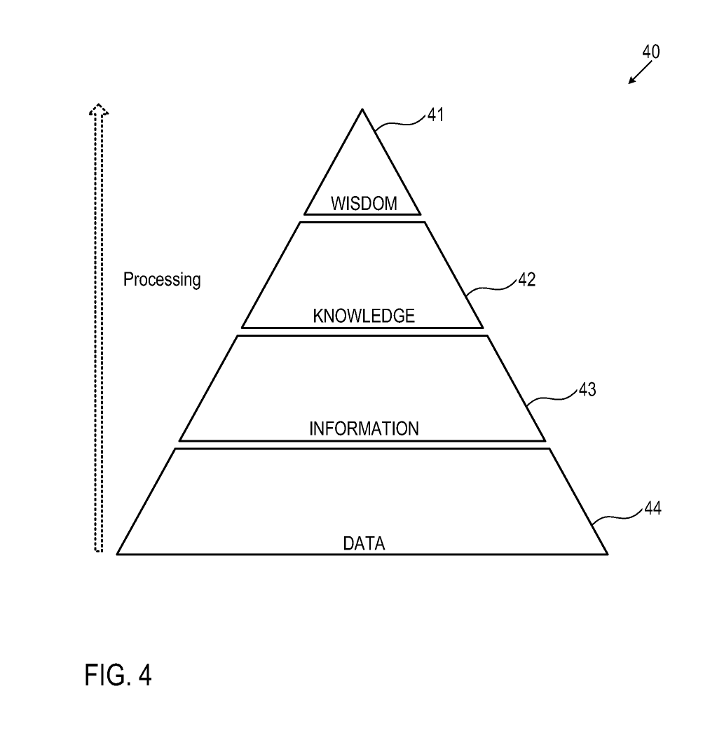

FIG. 4 is a Data-Information-Knowledge-Wisdom (DIKW) pyramid 40 depicting a hierarchy in which depicting how additional processing improves content from the lower data level to higher levels in which understanding is improved.

The different levels of the pyramid are defined as follows:

The Data level 44 generally refers to content that is directly sensed, unstructured, or structured content prior to any analytic processing.

The Information level 43 refers to content resulting from analytics, meaningful metadata, and fused data.

The Knowledge level 42 refers to information that has been enhanced with SME expertise, insights and intuition

The Wisdom level 41 refers to knowledge that has been further enriched with additional information (e.g., information from multiple CCs).

Whereas CCs deal with the lower levels of the pyramid (D, I and K), KC deals primarily with the upper 3 levels of the pyramid (I, K and W).

KC 1 may be designed so as not to process sensor data to minimize bandwidth requirements and other resource costs associated with moving huge amounts of data. On the other hand, CC may not be configured to generate wisdom because CC lacks the entire knowledge base that KC 1 has.

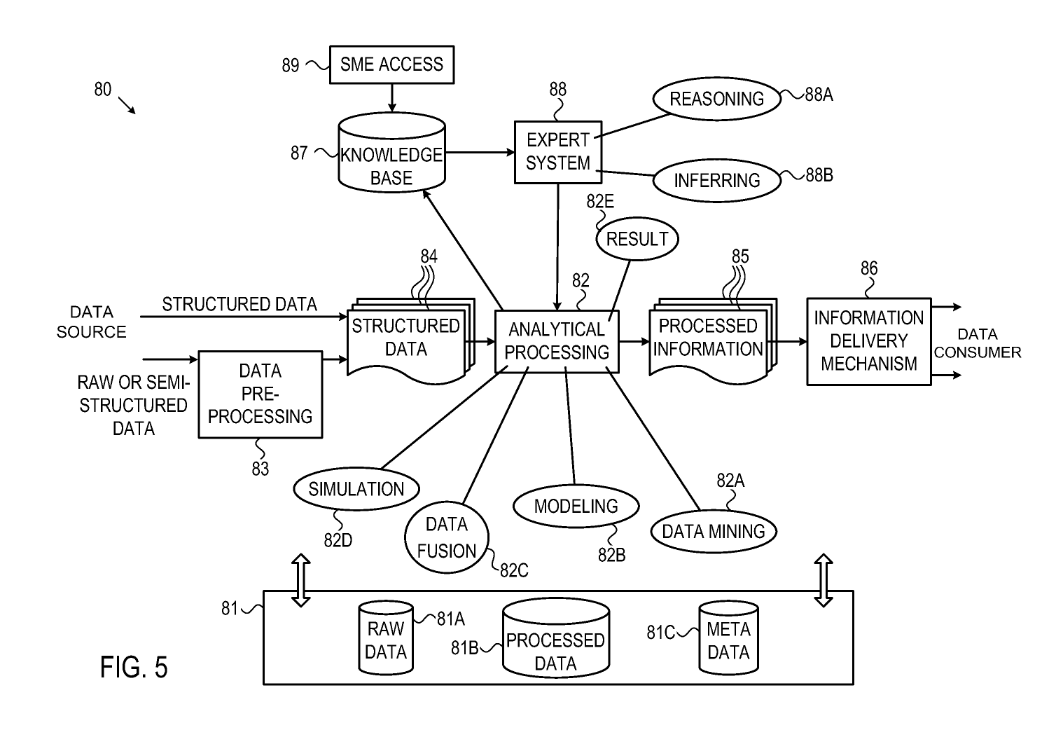

FIG. 5 is a high-level workflow 80 of a KC, depicting the processing employed to process, to analyze, and to ultimately distill useful, accessible and non-obvious knowledge from a variety of information types ranging from lower level processing of incoming data to higher-level analysis of contextualized and richer information.

In general terms, during basic analysis standard-format information that includes metadata such as a time stamp, information source, location of where the information was produced, enables the production of additional context automatically using engines like Rules Based Engines and basic Data Fusion, for example, for automatic recognition of relevant objects and their possible relationship to each other.

The recognition of relevant objects and their possible relationship to each other renders a much richer and more valuable set of objects, entities, relationships that can be manipulated by the next stages of analysis.

After a set of entities already exist, additional engines may be employed to perform a wide variety of analyses like, inter alia, time series analysis, pattern recognition, graph mining, estimation, prediction. The output of these engines can describe behaviors, activities, and estimate and predict future trends.

Simulation tools are used to deal with hypothetical situations and scenarios to simulate “What-If” situations.

Simulation tools are usually very domain specific and in some embodiments assist the placement of response forces or the identification of weaknesses.

Modeling, on the other hand, relies on systems that can be well described by a scientific or engineering model (e.g., gas dispersion, flood propagation), which can use real time or historic input data to predict how a given situation will evolve.

The fact that models are based on specific physical or engineering phenomena renders them very domain dependent; although in some embodiments, there can be overlap between domains.

One of the ways of doing so is through Subject Matter Expert (SME) approach in which an expert knowledge base (KB) is created from knowledge obtained from a human expert followed by a reasoning engine that can manipulate the KB and produce meaningful outputs.

Note that the expert knowledge base will also capture established operational knowledge such as Concept of Operations (CONOPS), domain specific best practices, plans, according to non-limiting embodiments.

Turning now to FIG. 5 in detail, as shown, structured and unstructured data is fed into KC from a data source. Raw or semi-structured data is pre-processed in step 83 and transformed into structured data 84 and then analytically processed at step 82.

The analytic processing may directed to processing like, inter alia, simulation 32D, fusion 32C, modeling 32B, or data mining 32A, or any combination of them.

The analytic result may be enriched by applying SME knowledge by fusing with the analytic result. A non-limiting example of such expert knowledge enrichment is as shown. The analytic result is stored in a dedicated knowledge base 87 and the appropriate expert knowledge is accessed from SME access 89.

Both the analytic result and the appropriate expert knowledge is fed into an expert system 88 where a reasoning engine 88A or an inference engine 88B is applied so as render the analytical result into a higher form of knowledge; i.e. result 82. Result 82 is stored as processed information 85 and then delivered to a non-obvious knowledge consumer via information delivery system 85, according to non-limiting embodiments.

As shown, data is stored in a database array 81 including raw data storage 81A, processed data 81B, and metadata 81C. Database array 81 is in a state of flux as various data types are input and output as processing proceeds, according to non-limiting embodiments.

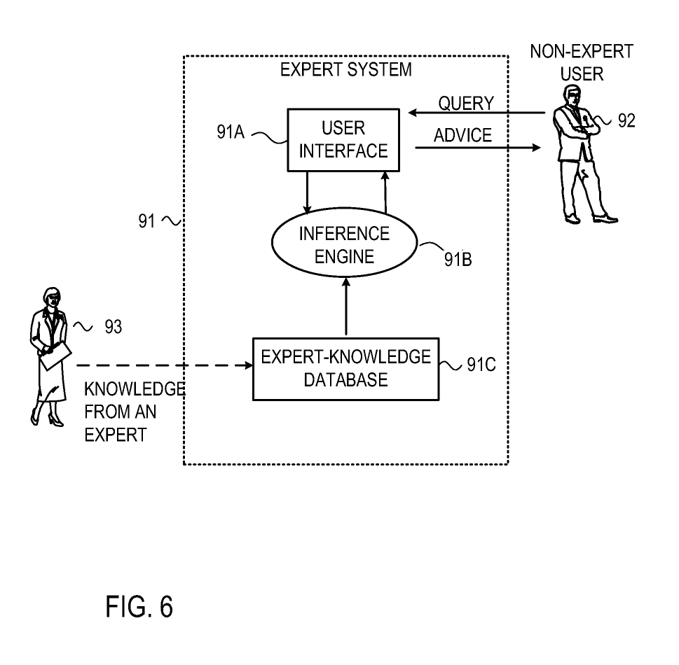

FIG. 6 is a schematic view of an expert system 91 employed by the KC, according to an embodiment. Specifically, expert system 91 consists of a user interface 91A in communication with an inference engine 91B linked to an expert-knowledge database of information obtained from an expert 93.

In operation, non-expert user 92 submits a query for non-obvious knowledge not found in a database through user interface 91A. An answer is generated by inference engine 91B based on expert information in expert-knowledge data-base 91C and returned to the non-expert user 92 through user interface 91A, according to embodiments. It should be appreciated that the non-expert user may also be an application configured to enrich results derived form prior analytics.

Another knowledge-based approach is known as Case Based Reasoning (CBR) based on cognitive science. Here the KB consists of “cases” that capture past experience and when a new case comes in, the system searches and retrieves “similar” cases. The selected case may need to be modified to meet the new case's specific attributes. The solution is tested and if necessary the exiting case in the KB is modified.

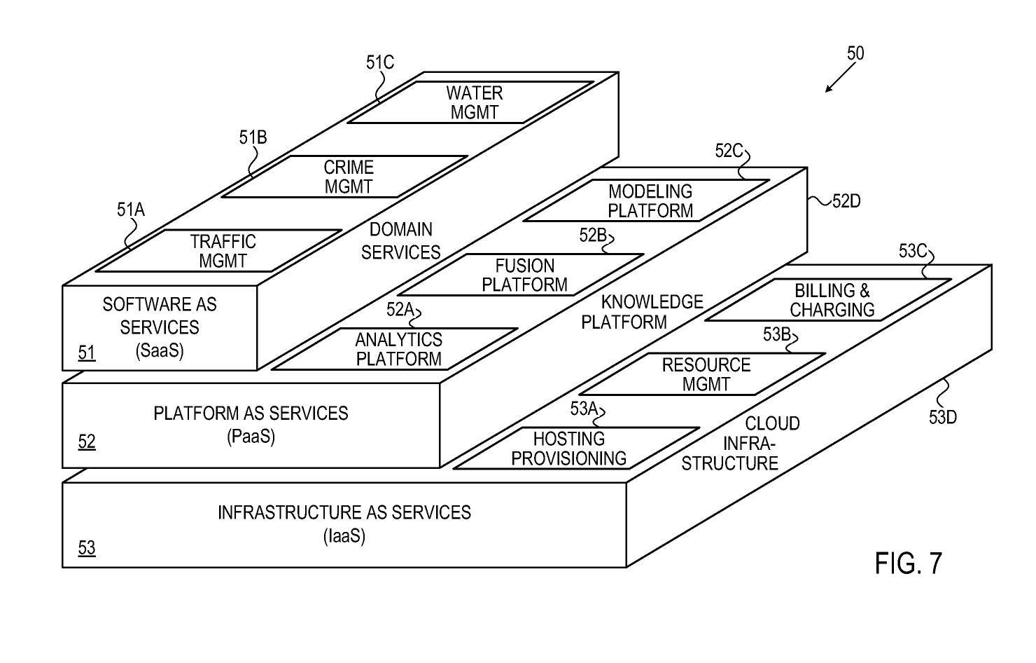

FIG. 7 is a cloud, system view 50 depicting XaaS layers 51-53, according to an embodiment. As shown, SaaS layer 51 represent multiple domains including traffic, crime and water management 51A-51C, respectively, according to some embodiments. Each domain is implemented as a separate KC with optional interconnections between the KCs for cross-domain problems.

As shown, PaaS 52 provides platform services including platforms for analytics, fusion and modeling 52A-52C, respectively.

Similarly, IaaS 53 provides infrastructure services including platforms, for hosting provisioning 53A, resource management 53B, and billing and charging 53C as an example. Many times, IaaS is simply offering up a hardware platform (storage, compute and network) as a service reducing the need of an enterprise to invest in building up such infrastructure in-house.

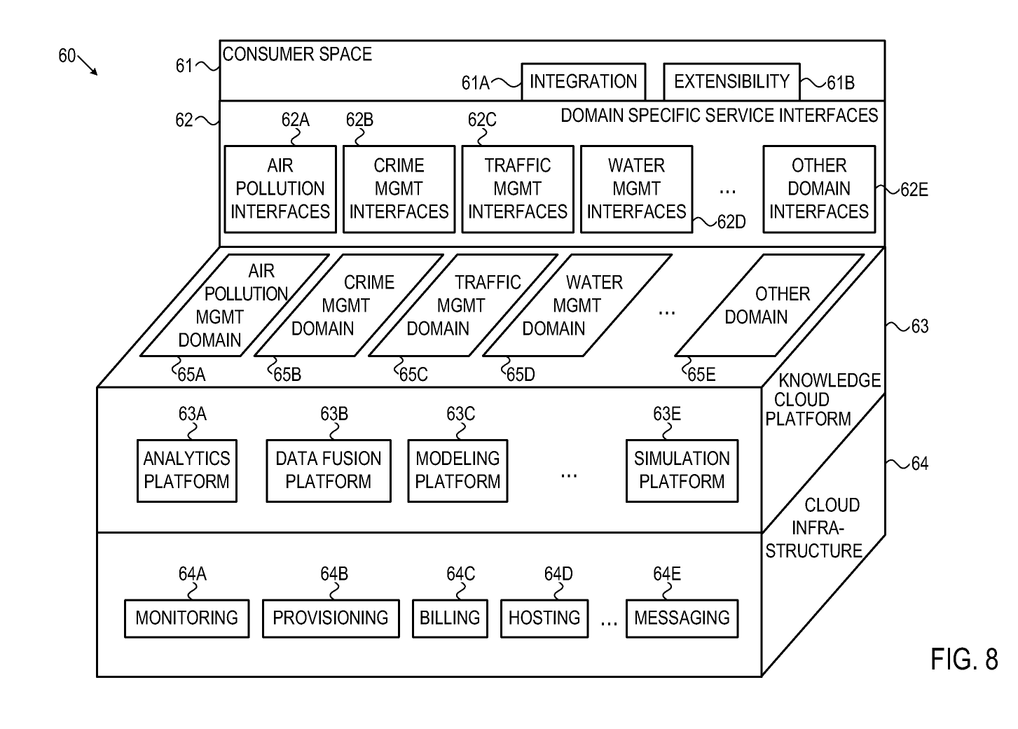

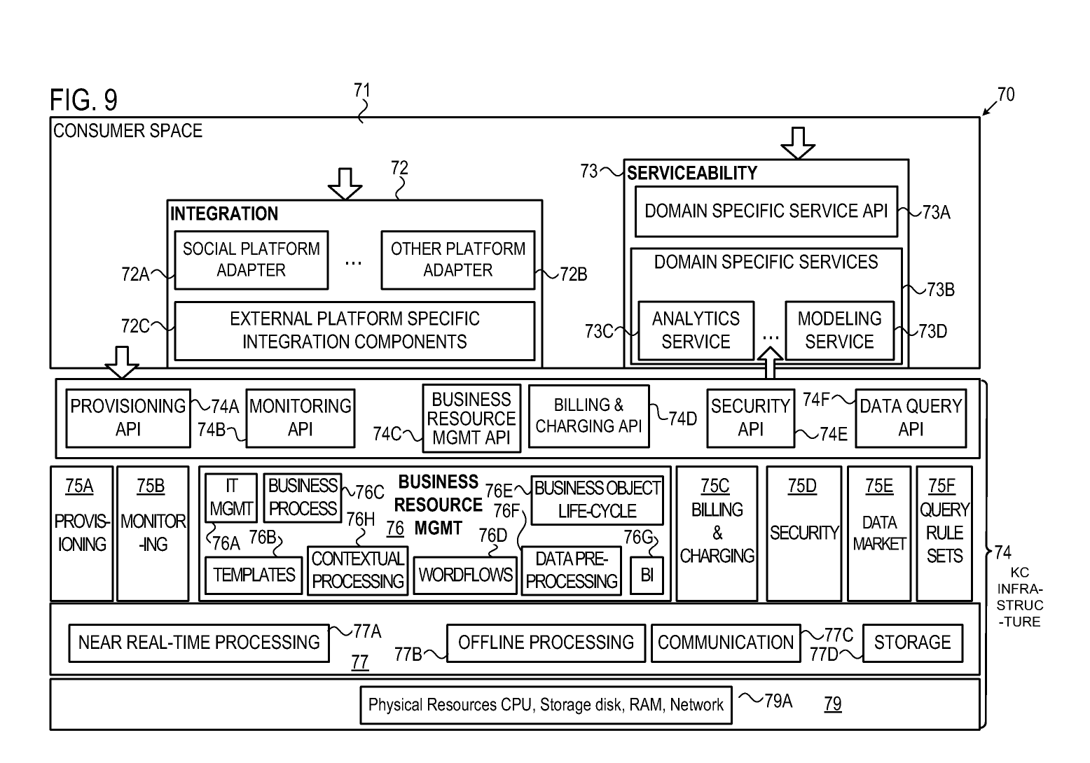

FIGS. 8 and 9 show in greater detail common infrastructural elements that could be used as a template for the construction of new KCs.

Specifically, FIG. 8 is a stacked system view 60 depicting infrastructural elements of a KC; cloud infrastructure 64 and KC platform 63. As shown, cloud infrastructure 64 includes infrastructures monitoring 64A, provisioning 64B, billing 64C, hosting 64D, and messaging 64E, according to a non-limiting embodiment.

Similarly, KC platform 63 includes platforms for analytics, data fusion, modeling, and simulation platforms 63A-63E, respectively.

KC platform 63 may further include a variety of domains including air pollution 65A, crime management 65B, traffic management 65C, water management 65D, and others 65E, according to a non limiting embodiment.

KC platform 63 may also include domain interfaces including air pollution 62A, crime management 62B, traffic management 62C, water management 62D, other domains 62E, according to a non-limiting embodiment.

KC platform 63 may also provide a consumer space 61 to accommodate integration with existing platforms or domains and extendibility 61B to additional domains.

FIG. 9 is a layered view depicting baseline high-level architecture of a KC 70 including physical infrastructure 79, an infrastructure layer 74, and a consumer space layer 71.

As shown, physical infrastructure 79 may include physical infrastructure like CPU, storage disk, RAM, network of networked computers, input and output devices and any other required hardware.

Infrastructure layer 74 contains baseline activity layer 77 including activities like near real-time processing 77A, offline processing 77B, communication 77C, and storage 77D, according to a non limiting embodiment.

Infrastructure layer 74 also includes provisioning 75A, monitoring 75B, billing and charging 75C, security 75D, data market 75E query rules 75F, and infrastructure business resource management 76 that also includes, IT management 76A, templates 76B, business process 76C, contextual processing 76H, word flows 76D, business-object life-cycle 76E, data pre-processing 76F, Business Intelligence (BI) 76G, according to a non limiting embodiment.

Infrastructure layer 74 also contains an API layer 74 including a provisioning API 74A, monitoring API 74B, business resource management API 74C, billing and charging API 74D, security API 74E, and a data query API 74F, according to a non limiting embodiment.

Consumer space layer 71 may include an integration layer 72 that includes a social platform adapter 72A, other platform adapter 72B, and external platform specific integration components 72C.

Consumer space layer 71 may also include a serviceability layer 73 including domain specific API 73A, domain specific services 73B that includes an analytics service 73C, and a modeling service 73C, according to a non limiting embodiment.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of distilling non-knowledge from unstructured data, the method comprising:
receiving unstructured data from a data source;
processing the data with a processing engine to render the unstructured data into structured data;
analyzing the structured data with at least one analysis engine so as to identify information;
processing the information with a reasoning engine or an inference engine so as to enhance the information with expert knowledge to form knowledge, the reasoning engine or the inference engine operative in accordance with an expert-knowledge database.

2. The method claim 1, wherein the data source is selected from the group consisting of sensor, database, crowd sourcing, and computer network.

3. The method of claim 1, wherein the analysis engine is selected from the group consisting of engines configured to perform data fusion, data mining, modeling, simulation, video analytics, machine learning, facial recognition, and Optical Character Recognition (OCR).

4. The method of claim 1, further comprising delivering the knowledge to a client selected from the group consisting of computer network, computer, and computer application.

5. The method claim 4, wherein the delivering the knowledge is implemented by a delivery method selected from the group consisting of on-demand data retrieval, scheduled data delivery, data publishing, data query response.

6. The method of claim 1, further comprising analyzing the knowledge with an analytics engine so as to render the knowledge into wisdom, the analytics engine operative in accordance with a repository of knowledge and information.

7. A knowledge management system comprising:
a first computer configured to process unstructured data with a process engine so as to render the unstructured data into structured data, the unstructured data received from at least one data source;
a second computer configured to:
analyze the structured data with an analysis engine so as identify information,
process the information with a reasoning engine or an inference engine so as to enhance the information into non-obvious knowledge, the reasoning engine operative in accordance with an expert-knowledge database.

8. The knowledge management system of claim 7, wherein the data source is selected from the group consisting of sensor, database, crowd sourcing, and computer network.

9. The knowledge management system of claim 7, wherein the analysis engine is selected from the group consisting of engines configured to perform data fusion, data mining, modeling, simulation, video analytics, machine learning, facial recognition, and Optical Character Recognition (OCR).

10. The knowledge management system of claim 7, wherein the second computer is further configured to deliver the knowledge to a client using a delivery method, the client selected from the group consisting of computer network, computer, and computer application.

11. The knowledge management system of claim 10, wherein the delivery method is selected from the group consisting of on-demand data retrieval, scheduled data delivery, data publishing, data query response.

12. The knowledge management system of claim 7, wherein the second computer is further configured to analyze the knowledge with an analytics engine so as render the knowledge into wisdom, the analytics engine operative in accordance with a repository of knowledge and information.

13. The knowledge management system of claim 7, wherein the first computer is implemented in a first computer network.

14. The knowledge management system of claim 8, wherein the second computer is implemented in a second computer network.

15. The knowledge management system of claim 7, wherein the unstructured data is selected from the group consisting of traffic data, pollution data, and crime data.

16. The knowledge management system of claim 7, wherein the second computer is further configured to apply Case Based Reasoning (CBR) to the information.

17. The knowledge management system of claim 7, wherein the first computer is further configured to analyze the structured data with an analysis engine so as identify information.

18. The knowledge management system of claim 17, wherein the analysis engine is selected from the group consisting of engines configured to perform data fusion, data mining, modeling, simulation, video analytics, machine learning, facial recognition, and Optical Character Recognition (OCR).

19. The knowledge management system of claim 7, wherein the first computer is further configured to process the information with a reasoning engine or an inference engine so as to enhance the information into non-obvious knowledge, the reasoning engine operative in accordance with an expert-knowledge database.

20. The knowledge management system of claim 7, wherein the first computer is further configured to apply Case Based Reasoning (CBR) to the information.
